(19) United States
(12) Patent Application Publication
(10) Pub. No.: US 2007/0209042 A1
(43) Pub. Date: Sep. 6, 2007

(54) Grid computing architecture & associated method of invoking/registering network services for subscription

(75) Inventors: Pramila Mullan, Los Gatos, CA (US); Sukesh Garg, San Jose, CA (US); Frederick Lee, Foster City, CA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: FRANCE TELECOM, Paris (FR)

(21) Appl. No.: 11/364,204

(22) Filed: Mar. 1, 2006

(51) Int. Cl. G06F 9/46

(52) U.S. Cl. 719/328

(57) ABSTRACT

A mediator host is provided for identifying services of networked resources which are available for invocation in a grid computing architecture. A mediator host Application Program Interface (API) is configured to receive a service registry query and related resource query. The API identifies the service registry query and related resource query by signature. A service registry query processing agent is configured receive an identified service registry query from the API, and, to communicate with a corresponding service registry to satisfy the query. A resource query processing agent is configured to receive an identified related resource query from the API, and, to communicate with a corresponding resource registry to satisfy the query. The mediator host returns a service query response which satisfies a predetermined resource metric to identify candidate services for invocation.

### BACKGROUND OF THE INVENTION

The present invention relates to a grid computing architecture and, more particularly, to a grid computing architecture and associated methodolgy for programmatically invoking/registering network services for subscription.

The “background” description provided herein is for the purpose of generally presenting the context of the invention. Work of the presently named inventors, to the extent it is described in this background section, as well as aspects of the description which may not otherwise qualify as prior art at the time of filing, are neither expressly or impliedly admitted as prior art against the present invention.

An executable service is a set of related executable functions which can be discovered or called (i.e., “programmatically invoked”) via an established network protocol. Such services include World Wide Web based services which are increasingly employed in carrying out the functions of composite applications. The leveraging of network distributed web services to function togther as a composite application is referred to as grid computing or distributed object computing.

In operation, a grid computing architecture employs the web services as an application integration technology. Each web service is supported by a resource of the grid computing network. For example, in an Internet grid computing environment, individual web services may be supported by an execution environment, such as a corresponding web server. The information necessary to programmatically invoke the web service is defined in a Web Services Description Language (WSDL) document or Interface Definition Language (IDL). These documents are stored in a registry of the grid computing framework so that applications seeking subscription to a specific service can locate and invoke the necessary service. One well known type registry of web services is the Universal Description, Discovery and Integration (UDDI) registry. This registry type would include the location of the service and the necessary information for integrating this service in an application of the grid computing framework. Using the necessary information, an application can remotely call the service though an Extensive Mark-up Language (XML) based messaging protocol such as the Simple Object Acess Protocol (SOAP) or Object Request Broker (ORB) of the Common Object request broker Architecture (CORBA).

Efficient discovery of grid services and resources is an essential building block for a grid computing framework. The prevalent standard for web service discovery is UDDI. In order to gauge the resource supporting the web service, typically, the Globus Toolkit's Monitoring and Discovery Service (MDS) is utilized. The Globus Toolkit's MDS is particularly suited for registering resources.

Yet, grid computing environments typically offer numerous resources with no indication of the service availability or resource information where these services are available. It is practically impossible to choose a resource for subscription because there is no way to determine whether the resource is being used by other services or whether the resource is heavily utilized or underutilized.

Presently, there is a need for an interface service that transparently mediates queries for identifying and/or registering both resources as well as services associated with the resources.

### SUMMARY OF THE INVENTION

The present invention provides a mediator host provided for identifying services of networked resources which are available for invocation in a grid computing architecture. A mediator host Application Program Interface (API) is configured to receive a service registry query and related resource query. The API identifies the service registry query and related resource query by signature. A service registry query processing agent is configured receive an identified service registry query from the API, and, to communicate with a corresponding service registry to satisfy the query. A resource query processing agent is configured to receive an identified related resource query from the API, and, to communicate with a corresponding resource registry to satisfy the query. The mediator host returns a service query response which satisfies a predetermined resource metric to identify candidate services for invocation.

In a further aspect of the invention, a grid computing architecture is provided for invoking services of networked resources to execute a composite application. A client node of the architecture is configured to provide a service registry query, and, an associated service resource query of the grid computing architecture. The service registry query and associated resource query have different message signatures. A mediation node includes an application program interface (API) which is configured to receive the service registry query and associated resource query. The API identifies the service registry query and associated resource query by signature. A service registry query processing agent is configured to receive an identified service registry query from the API, and, to communicate with a corresponding service registry to satisfy the query. A resource query processing agent is configured to receive an identified associated resource query from the API, and, to communicate with a corresponding resource registry to satisfy the query. The mediation node returns a service query response which satisfies a predetermined resource metric to identify candidate services for invocation.

In still a further aspect of the invention, a computer readable carrier includes computer program instructions that cause a computer to implement a method of identifying services of networked resources available for invocation in a distributed object computing architecture. A service registry query and related resource query are received at an API, the service registry query and related resource query have different signatures. The service registry query and related resource query are identified by signature. The identified service registry query of the API is processed by communicating with a corresponding service registry to satisfy the query. The identified related resource registry query of the API is processed by communicating with a corresponding resource registry to satisfy the query. A service query response is returned which satisfies a predetermined resource metric to identify candidate services for invocation.

It is to be understood that both the foregoing general description of the invention and the following detailed description are exemplary, but are not restrictive, of the invention.

### BRIEF DESCRIPTION OF THE SEVERAL VIEWS OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a high level block diagram of a computing architecture in accordance with an exemplary embodiment of the invention;

FIG. 2 is a more detailed block diagram of the mediator interface of the exemplary embodiment of FIG. 1;

FIG. 3 is an exemplary impementation of the mediator interface of FIG. 2;

FIG. 4 is a is class diagram of the mediator interface of FIG. 3;

FIG. 5 is a process flow of a new service and related resource registration process in accordance with an exemplary embodiment of the invention;

FIG. 6 is a process flow of a new resource registration process in accordance with an exemplary embodiment of the invention;

FIG. 7 is a process flow of a new service and existing resource registration process in accordance with an exemplary embodiment of the invention;

FIG. 8 is a process flow of a replacement resource registration process in accordance with an exemplary embodiment of the invention;

FIG. 9 is a process flow of a service query in accordance with an exemplary embodiment of the invention; and

FIG. 10 is a is a process flow of a resource query in accordance with an exemplary embodiment of the invention.

### DETAILED DESCRIPTION OF THE INVENTION

Certain terminology used in the following description is for convenience only and is not limiting. The term “service” as used herein, is not limited exclusively to a single function, but embraces sets of related functionality. Likewise, the term “resource” as used herein is not limited to a single metric of a related service, but, instead, also embraces a set of metrics which describe the operating environment of the related service. In the drawings, the same reference numerals are used for designating the same elements throughout the several figures.

The present invention provides efficient discovery/registration of grid services and associated resources. In a grid computing architecture or distributed object computing environment, a client device or application invokes web services for executing a composite task. Web service communities have addressed the need for service discovery, via an industry standard called universal description, discovery integration (UDDI). UDDI registries can be either public, or private. For example, enterprises may deploy private UDDI registries for use within their organizations. In addition to the registration of services, there are registries which include information on service resources, such as the web services version of the Monitoring and Discovery Service (WS MDS), also known as the MDS4 component of the Globus Toolkit version 4 (GT4).

A mediator interface in accordance with an exemplary embodiment of the invention is provided as an extended WS UDDI service container exposing a single application program interface (API) for registering and discovering both resources and services. The API supports a unified query for both services and resources on which the services are running. The API allows for querying a service with a given resource property (e.g., resource metric(s) in a specific range) and at the same time ensuring that the queried service is available. This converged approach considerably reduces the result set by eliminating services which are out of scope or resources that are not available.

I. Architecture

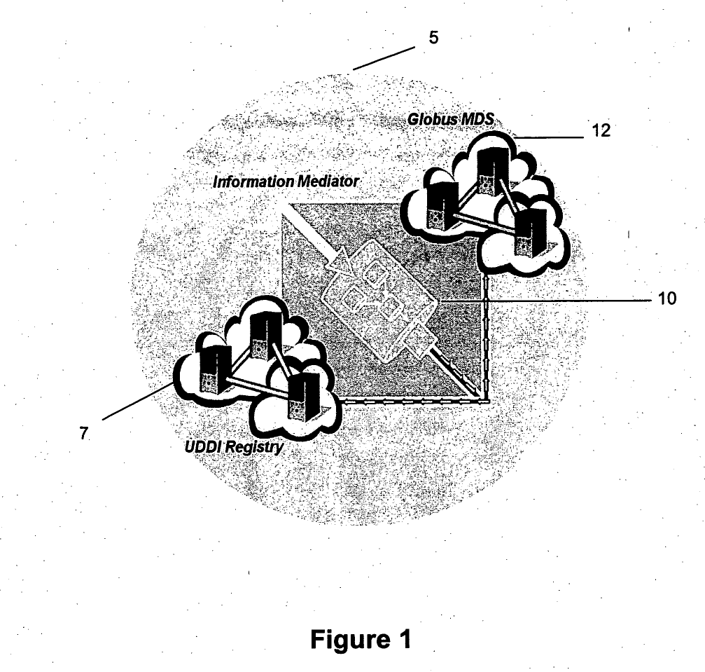

Referring now more specifically to FIG. 1, a high level block diagram of a grid computing architecture 5 in accordance with an exemplary embodiment of the invention is shown. The architecture includes a UDDI registry 7 a mediator interface 10 (i.e., information mediator) and a Globus MDS registry 12.

The exemplary architecture 5 converges both UDDI and MDS with both solutions working in a symbiotic relationship. Services are registered in UDDI registry 7 and resources are registered in MDS registry 12. The architecture 5 employs the mediator interface 10 to present services and resources in a distributed system using a unified application program interface (API). The architecture 5 builds an overlay network of UDDI registries and Globus MDS based on the mediator interface 10, where the interface 10 acts as a rendezvous network that connects the multiple registries. The interface 10 sits at the very front of the architecture 5 to process all of the incoming messages as well as redirection to the appropriate sub-function. As outlined in more detail below, those skilled in the art will recognize that alternative registry types are embraced by the exemplary architecture 7.

As outlined below UDDI is the standard API to register and query services stored in a registry, such as UDDI registry 7. Exemplary UDDI registry 7 has a well structured information model that effectively represents the relationship between the business, service and technical information. UDDI registry 7 does not effectively represent dynamic state information for services and resources and perform queries on them.

A UDDI registry 7 as employed in the exemplary embodiment of the invention, enables a registrant to identify types of information therein—white page data, yellow page data and green page data. In the yellow pages, registrants register an identity and their services under different categories, the same as in the familiar telephone yellow pages. In UDDI, here too, the white pages are a listing of entities. The green pages represent the technical information that is necessary to invoke a given service. Thus, by browsing UDDI registry 7, an application developer should be able to locate a service and a company and find out how to invoke the service. Furthermore, UDDI has been designed to support not just developers or users but also client applications that can dynamically, in real time, search for and consume services programmatically with no manual intervention.

UDDI offers APIs to publish and inquire with respect to web services. These APIs are quite simple to use as the UDDI registry itself is exposed as a web service using the Simple Object Application protocol (SOAP). Of course, those skilled in the art will recognize that other registries may employ alternative XML envelopes such as DIME, W3C and CORBA.

UDDI's tModel is a general purpose data structure of linking metadata outside of UDDI. The tModel is used for example for defining service types or for pointing to metadata about a business and service registered with UDDI. Furthermore, since UDDI is expected to hold hundreds of thousands of registrants and services, it is necessary to categorize them for easy use based on, for example, geography, industry type, service type, etc. UDDI offers a useful concept called a Category Bag to create its taxonomy. However, the application of UDDI is not well suited for registering and management of stateful resources.

Globus MDS registry 12 provides a resource registration and discovery service. A function of registry 12 is to provide a mechanism to query and update resource information. Exemplary registry 12 is an ideal way to represent dynamic attribute of resource, however, this information model is too simplified to show a variable aspect relationship.

The Monitoring and Discovery Service (MDS) from Globus Toolkit is a set of web services for monitoring and discovering resources in a grid computing architecture 5. A query typically returns a set of resources that can complete a job in shortest amount of time with the most efficient use of resources. The resource selection process involves using static information such as CPUs, clock speed, physical memory, virtual memory and disk space. In addition, dynamic information is also used such as current available CPUs, number of jobs queued and current CPU and memory utilization.

The MDS service for gathering the resource information is the Index Service. It collects the information and publishes it as a resource property and provides it via a web service. At any given time, the information presents the current configuration and state of the grid resources. It is maintained as a set of Web Service Resource Framework (WSRF) resource properties. MDS also provides subscription and notification on a resource property using the Trigger Service. It can execute policies, defined earlier, once a specified threshold has been exceeded. The Index service and the Trigger services are built on the MDS Aggregation Framework. The framework offers a hierarchical index service registration enabling the consolidation of data from multiple locations into a single point. Queries can be made against the resource attributes which represent the state and configuration of the resource.

The MDS resource attributes are maintained in a “soft state” by associating a lifetime to it. This ensures the removal of stale information. Since MDS maintains configurations and services in a soft state, constant updates are required in order to renew/update these services. Services are registered using the service registration file. The service registration file contains the grid resource, the service group the resource should register with and service configuration parameters.

MDS does solve the resource discovery and monitoring problem. However, MDS does not offer the flexibility and functionality offered by UDDI for service discovery. For example, there is no taxonomy available in MDS such as UDDI's “category bag”. Furthermore, there is no simple way to make a query for a specific service where the resource attribute falls in a specified range. MDS needs complex xPath query language in order to identify a specific service. It is not sufficient to simply identify a resource offering the service without identifying the resource that is capable of servicing the request. For example, the existence of the service is irrelevant if the underlying resource of the service is incapable of servicing a request. Resource parameters which indicate such ability are dynamic in nature, for example CPU utilization or available memory. Leveraging UDDI to provide service information and MDS to provide resource information and mediating as described herein improves service/resource discovery and registration.

The exemplary mediator interface 10 provides a unified and efficient uniform distributed service API. The mediator interface 10 leverages the fact that every service has an end point identified by the physical location of the service. The end point is modeled as a resource, leading to the concept that every service is associated with a resource. Furthermore, a resource can exist without a service.

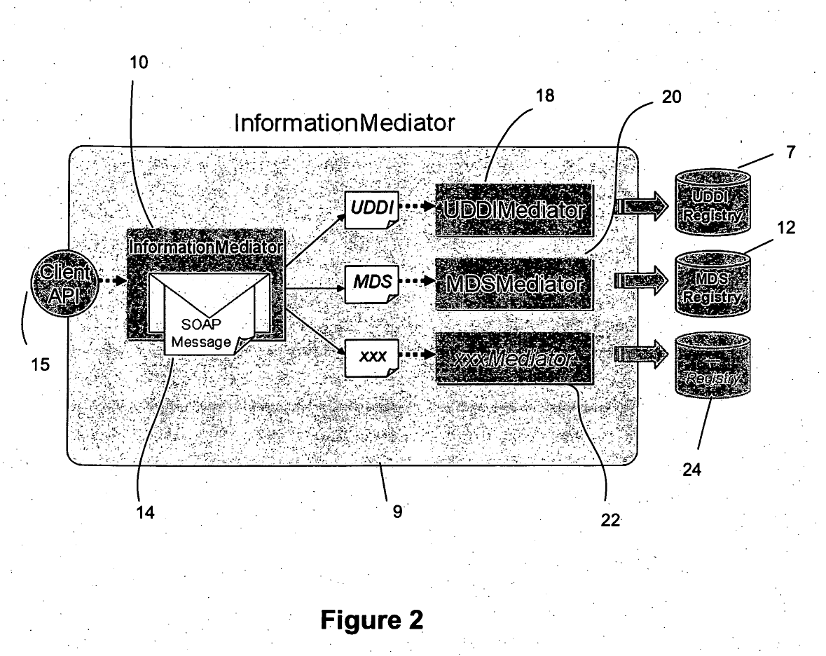

Referring now to FIG. 2, a more detailed diagram of mediator interface 10 is shown embodied in a grid service container framework 9. The interface 10 mediates the communications between client 15 and backend registries such as UDDI registry 7 and MDS registry 12. The interface 10 communicates with the UDDI and the MDS registries using different protocols. As such, incoming messages 14 to the mediator interface 10 are consumed by a specific registry agent. In the exemplary embodiment, two agents are provided, namely a “UDDIMediator” 18 and “MDSMediator” 20. As the name refers, UDDIMediator 18 processes UDDI related messages and MDSMediator 20 processes MDS related messages. This pluggable framework guarantees maximum flexibility to enable the addition of an auxiliary specification to the existing mediator framework without any major modification. For example, XXX mediator 22 and registry 24 illustrated in phantom reinforce the plugablity of the architecture 7.

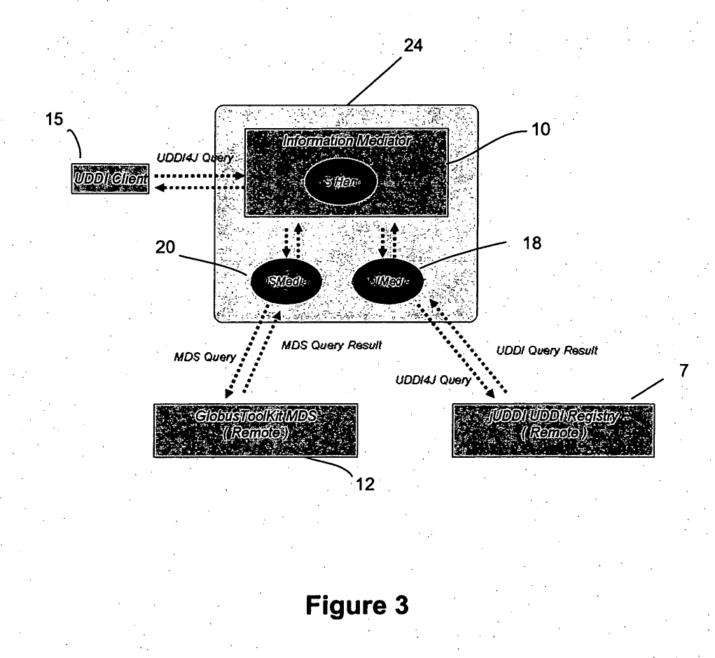

In an exemplary implementation shown in FIG. 3, the mediator interface 10 is implemented using an WS UDDI service container on top of an Apache Axis running on a server 24. A function of interface 10 is to intercept incoming XML envelopes, such as SOAP messages 14 and determine if they are for UDDI registry 7 or MDS registry 12, or both. In order to achieve this, the interface 10 leverages the architectural strength of AXIS which has a layered chain of handler processes. In this way, the exemplary Axis handler inspects incoming SOAP messages 14 and, based on the encoding scheme of UDDI and MDS, it forwards the message content to the appropriate Mediator agent (e.g., MDSMediator 20, UDDIMediator 18). To forward the message, standard WSRP API for MDS and UDDI4J API for UDDI operation are employed.

In the exemplary implementation, those skilled in the art will recognize that the architectural strength of this architecture 7 is the ability to add any kind of protocol to the framework with no changes required to existing clients, services and registries. With the abstraction layer upon heterogeneous registry environment, the client 15 is agnostic to whether the service entry is for the UDDI registry 7 or the MDS registry 12. The mediator interface 10 will transform any messages 14 passing therethrough to the appropriate protocol understood by the respective registry. The interface 10 is provided to the client 15 as a multiple registry implementation. No matter what registry is supported, client 15 can leverage the single API of the exemplary architecture.

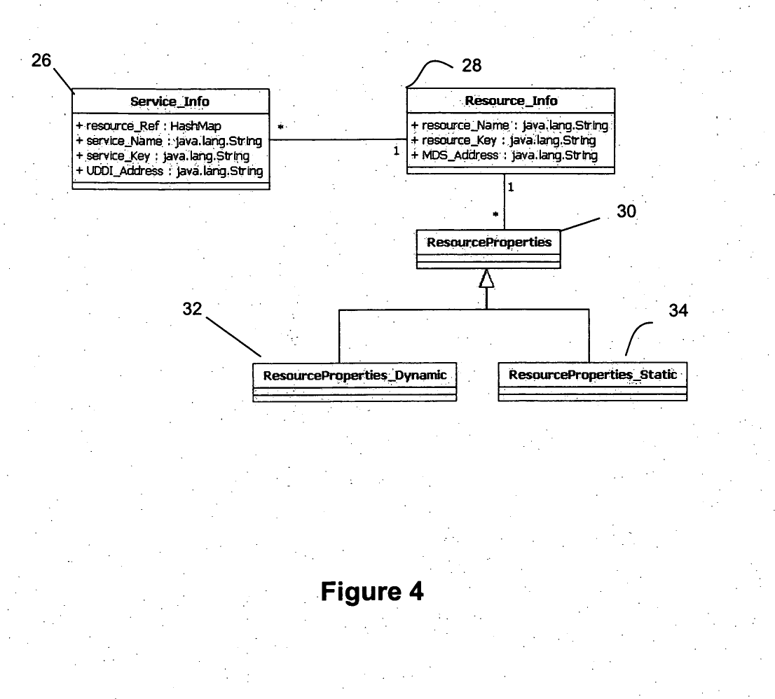

Referring now to FIG. 4 a class diagram of the mediator interface shows the association with resource and resource property. The Service_Info 26 can have an associated resource 28 and the associated resource 28 can have multiple resource properties 30 which may include static 32 and/or dynamic properties 34.

With the exemplary architecture 5 for example, a query “Find a Translation Service on a Resource where CPU utilization is less then 40%” may be processed by the exemplary mediator interface 10 to leverage the UDDI registry 7 and the MDS registry 12 to fulfill the request. The mediator interface 10 communicates with UDDI registry 7 for service discovery, and, with the MDS directory 12 for resource discovery.

In more detail, a service request is made to an International News server. The request indicates an interest in getting news articles from various French news servers for presentation in English. This request is processed by the International news server (i.e., client 15) and mediated by the interface 10 of the present invention. The mediator interface 10 identifies all French News servers with no indication of the resource parameters via UDDI registry 7. In addition, the request of the International news server indicates the mediator interface 10 service list the translation servers where CPU utilization is less than 40%. The mediator interface 10 communicates with MDS registry 12 to identify the resources of the UDDI service listings retrieved.

In this way, the mediator interface 10 provides the corresponding news service listings and translation services with the related resources identified to the international news server (client 15). The “French News” servers are then accessed by the international news server to get the news in French. The news is translated into English by sending the news to the list “Translation Server” returned by the mediator interface 10 where CPU utilization is less than 40%. The translated news is then presented to the user by the international news server.

II. Methodology

Any process descriptions in the process flow diagrams should be understood as representing specific aspects of circuit operation, or steps in the process. Alternate implementations are included within the scope of the exemplary embodiment of the present invention in which functions may be executed out of order from that shown or discussed, including substantially concurrently, depending upon the functionality involved, as would be understood by those skilled in the art.

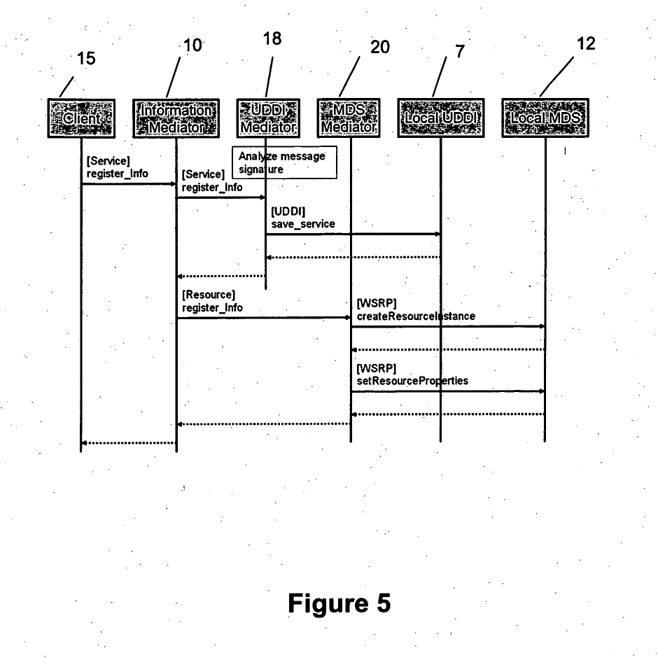

As outlined below, process flow diagrams in accordance with an exemplary embodiment of the present invention are described relative to FIGS. 5-10—adding a new service, adding a resource, adding a new service to an existing resource, replace the resource offering a service, querying for service with resource properties and querying a resource. Other operations like updating, deleting a service/resource, etc. are similarly processed and are omitted for the sake of brevity.

FIG. 5 illustrates a process flow detailing the client 15 publishing a new service to the UDDI registry 7. In order to interact with the server of the mediator interface 10 (hereinafter Information Mediator), client 15 has to be aware of the location of the server 10. The client 15 sends a service registration request to the information mediator 10. The information mediator 10 analyzes the registration request by looking at the signature of the message and determines whether to forward it to the UDDImediator 18 or the MDSmediator 20. Assuming that the request is for the UDDImediator 18, the information mediator 10 forwards the service registration request to the UDDI registry 7 using the UDDImediator 18 and receives the UDDI key from the UDDI registry 7.

As mentioned above, services may be associated with a resource; the information mediator 10 extracts the endpoint information from the initial request and sends a resource registration request to MDS registry 12. MDS registry 12 sends the resource key to the information mediator 10 which is used to make the association between the service and the resource. Retrieval of the resource information associated with the service is done by service UUID key, service name or resource URL (endpoint).

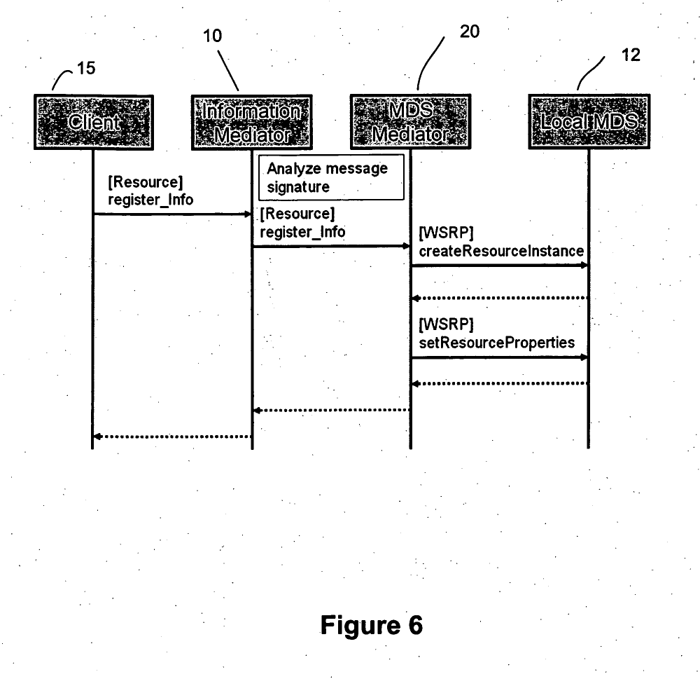

The process flow of FIG. 6, a client 15 can publish new resources to a registry. Resources can be registered with their associated resource properties without service association. A standalone resource can be associated to the service. By analyzing signature of the message, the information mediator 10 forwards the resource registration request to MDSmediator 20. On receipt of registration confirmation from MDS registry 12, the information mediator 10 sends response message to the client 15.

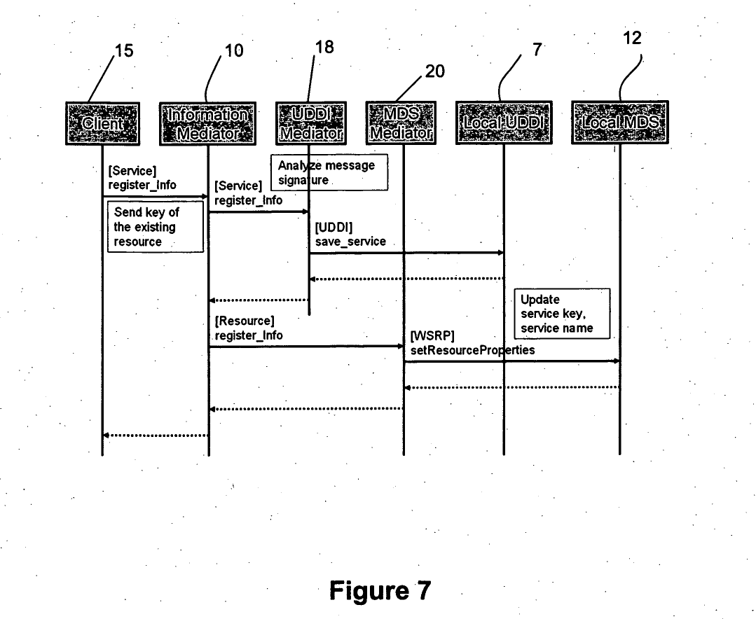

The process flow of FIG. 7 details a client 15 adding the service with an existing resource in the MDS registry 12. The service registration request leverages the existing resource entry and dynamically establishes the relationship between the service and the resource.

The client 15 sends service registration request to the information mediator 10 with existing resource information specified in the endpoint for the service. Then, information mediator 10 analyzes the message signature and retrieves resource information (i.e., which client to use.) The information mediator 10 forwards service registration request to UDDI registry 7 and waits for completion. Upon receiving the registration response from UDDI registry 7, information mediator 10 creates an association between new service and existing resource by sending new service key and service name to the resource.

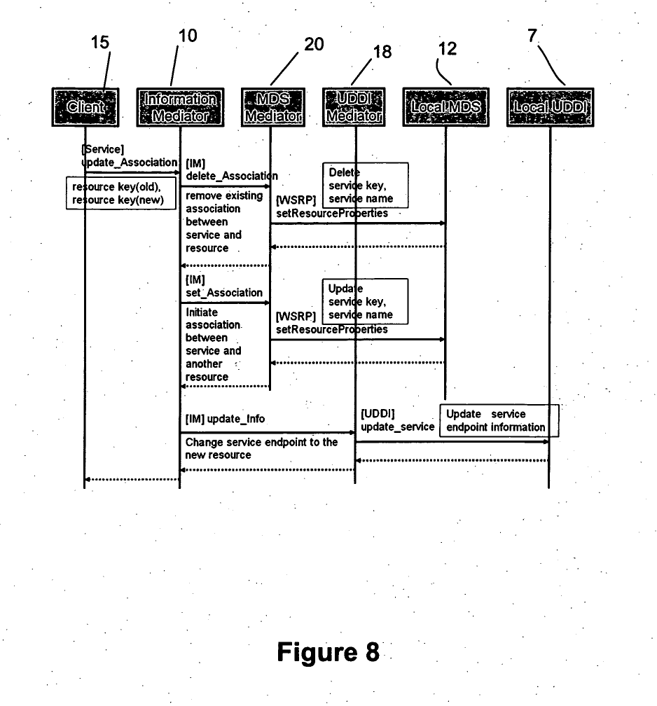

FIG. 8 shows a process diagram on how a client 15 replaces existing resource associations to a service with another resource which already exists. Since resources can exist without any association to a service, clients 15 can easily replace resources associated with a service.

The client 15 sends an update association request to the information mediator 10 with the service and the resource information for two resources. One is for the resource currently associated with the service and the other is for the resource the client 15 wants to associate the service with. To remove the existing relationship between service and old resource, the information mediator 10 deletes the service key and service name value of resource properties on the old resource. The old resource can now be used to serve other services. Finally, the information mediator 10 establishes the relationship between service and new resource by sending new service key and service name to the new resource.

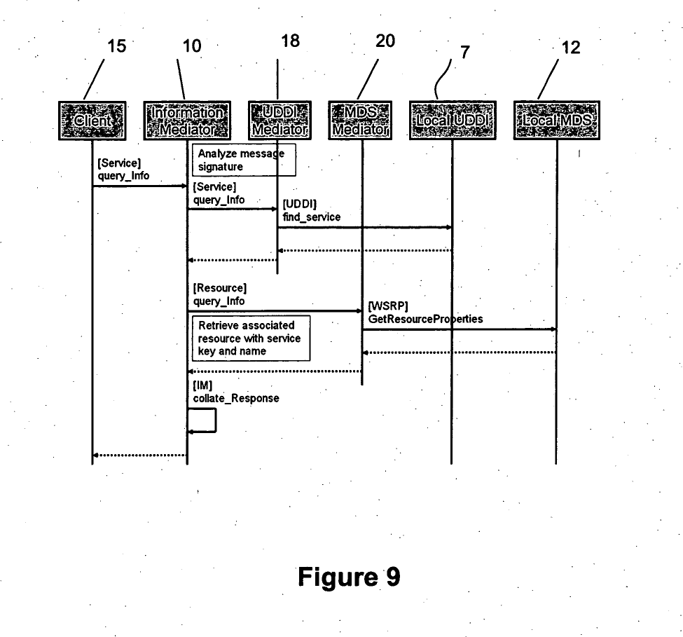

The process flow of FIG. 9 details a client 15 can query the service with a given set of resource properties. Every service has at least one resource associated with it. The operation returns the set of services that satisfy the query parameters which exist on resources which satisfy the resource query parameters. This operation is transparent to the client 15. The client 15 sends the service query to the information mediator 10. The information mediator 10 analyzes the request by looking at the message signature and determining the kind of request. Since the request is a service query it then, forwards the requests to the UDDI registries 7. On receipt of the response, the information mediator 10 forwards the resource query-with the requested resource properties to MDS registry 12. The result of resource query shows the set of resources which serve specific service and hold properties client is seeking. The information mediator 10 selects only services served by those resources from the service query result. And finally, returns the service list to the client 15.

The information mediator 10 can narrow down the service list by combining resource information. That means client 15 can get the service list what it actually wants to use. In this sequence of operations, the client 15 was unaware of the association between the service and the resource and was able to get the information request via the unified API of the information mediator 10.

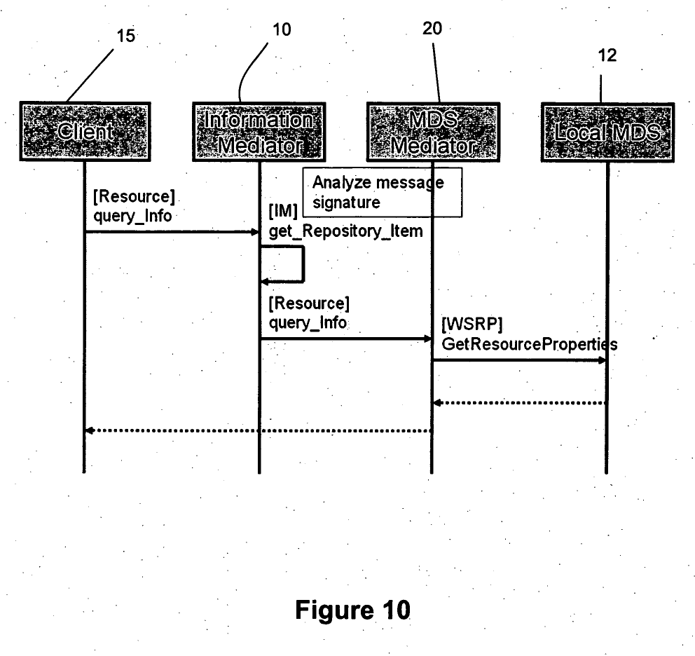

FIG. 10 shows the process flow of operations for resource queries with a given set of resource properties. The information mediator 10 will analyze the request and determines the kind of request. Once it has established that it is a resource query request, it then forwards the requests to the MDS registry 12 along with the set of resource properties. Upon receiving the responses, the information mediator 10 collates all responses and returns the aggregated set of resources to the client 15.

The resource query operation is transparent to the client 15, so the client 15 isn't aware of the complex WSRP query protocol. The client 15 simply sends the queries to the API of the information mediator 10. The information mediator 10 then generates WSRP query request (XPATH Query) and forwards it to MDS 12.

Obviously, readily discernible modifications and variations of the present invention are possible in light of the above teachings. It is therefore to be understood that within the scope of the appended claims, the invention may be practiced otherwise than as specifically described herein. For example, while described in terms of hardware/software components interactively cooperating, it is contemplated that the system described herein may be practiced entirely in software. The software may be embodied in a carrier such as magnetic or optical disks, or a radio frequency or audio frequency carrier wave.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

What is claimed is:

1. A mediator host identifying services of networked resources available for invocation in a grid computing architecture, comprising:
a mediator host Application Program Interface (API) configured to receive a service registry query and related resource query, the API identifying the service registry query and related resource query by signature;
a service registry query processing agent configured receive an identified service registry query from the API, and, to communicate with a corresponding service registry to satisfy the query;
a resource query processing agent configured to receive an identified related resource query from the API, and, to communicate with a corresponding resource registry to satisfy the query,
wherein, the mediator host returns a service query response which satisfies a predetermined resource metric to identify candidate services for invocation.

2. The mediator host of claim 1, wherein the service registry query is a Simple Object Application Protocol (SOAP) message.

3. The mediator host of claim 1, wherein a server provides an Apache Axis WS container as the mediator host.

4. The mediator host of claim 3, wherein the mediator host employs a process handler of the Apache Axis WS to identify the different message signatures.

5. The mediator host of claim 1, wherein the service registry is a Universal Description, Discovery and Integration registry (UDDI).

6. The mediator host of claim 1, wherein the resource registry is a Monitoring and Discovery Service (MDS) registry.

7. The mediator host of claim 4, wherein the different message signatures correspond to UDDI and MDS encoding.

8. A grid computing architecture for invoking services of networked resources to execute a composite application, comprising:
a client node configured to provide a service registry query, and, an associated service resource query of the grid computing architecture, the service registry query and associated resource query having different message signatures;
a mediation node having an application program interface (API) configured to receive the service registry query and associated resource query, the API identifying the service registry query and associated resource query by signature;
a service registry query processing agent configured receive an identified service registry query from the API, and, to communicate with a corresponding service registry to satisfy the query; and
a resource query processing agent configured to receive an identified associated resource query from the API, and, to communicate with a corresponding resource registry to satisfy the query,
wherein, the mediation node returns a service query response which satisfies a predetermined resource metric to identify candidate services for invocation.

9. The grid computing architecture of claim 8, wherein the service registry query is a Simple Object Application Protocol (SOAP) message.

10. The grid computing architecture of claim 8, wherein the service registry is a Universal Description, Discovery and Integration registry (UDDI).

11. The grid computing architecture of claim 8, wherein the resource registry is a Monitoring and Discovery Service (MDS) registry.

12. The grid computing architecture of claim 8, wherein the different message signatures correspond to UDDI and MDS encoding.

13. A computer readable carrier including computer program instructions that cause a computer to implement a method of identifying services of networked resources available for invocation in a distributed object computing architecture, comprising:
receiving a service registry query and related resource query at an API, the service registry query and related resource query having different signatures;
identifying the service registry query and related resource query by signature;
processing the identified service registry query of the API;
communicating with a corresponding service registry to satisfy the query;
processing the identified related resource registry query of the API;
communicating with a corresponding resource registry to satisfy the query; and
returning a service query response which satisfies a predetermined resource metric to identify candidate services for invocation.

14. The computer implemented method of claim 13, wherein the service registry query is a Simple Object Application Protocol (SOAP) message.

15. The computer implemented method of claim 13, wherein the service registry is a Universal Description, Discovery and Integration registry (UDDI).

16. The computer implemented method of claim 13, wherein the resource registry is a Monitoring and Discovery Service (MDS) registry.

17. The computer implemented method of claim 13, wherein the different message signatures correspond to UDDI and MDS encoding.
